(19) United States
(12) Patent Application Publication
(10) Pub. No.: US 2011/0004588 A1
(43) Pub. Date: Jan. 6, 2011

(54) METHOD FOR ENHANCING THE PERFORMANCE OF A MEDICAL SEARCH ENGINE BASED ON SEMANTIC ANALYSIS AND USER FEEDBACK

(75) Inventors: Amir Leitersdorf, Herzeliya (IL); Iri Amirav, Tel-Aviv (IL); Tzachi Shahar, Kfar-Saba (IL); Yuval Shahar, Omer (IL)

Correspondence Address: FOLEY HOAG, LLP;PATENT GROUP, WORLD TRADE CENTER WEST, 155 SEAPORT BLVD, BOSTON, MA, 02110, US

(73) Assignee: iMedix Inc., New York, NY (US)

(21) Appl. No.: 12/777,805

(22) Filed: May 11, 2010

Related U.S. Application Data
(60) Provisional application No. 61/177,108, filed on May 11, 2009.

(51) Int. Cl. G06F 17/30

(52) U.S. Cl. 707/711; 707/713; 707/E17.017; 707/E17.108

(57) ABSTRACT

Method for enhancing the performance of a medical search engine, including the procedures of generating an inverted index of medical related documents, receiving a medical search query from a user, expanding and augmenting the received medical search query thereby generating an enhanced medical search query, retrieving all the medical related documents in the inverted index which are relevant to the enhanced medical search query, ranking the retrieved medical related documents according to a master expression, presenting the ranked retrieved medical related documents to the user, receiving at least one user feedback response from the user to a respective one of the ranked retrieved medical related documents, for each received user feedback response evaluating and storing at least one feature of the respective one of the ranked retrieved medical related documents and modifying the master expression based on the received user feedback response using at least one machine learning algorithm.

### RELATED APPLICATIONS

This application claims priority to U.S. Application No. 61/177,108 filed on May 11, 2009. This application is incorporated herein in its entirety by this reference.

### FIELD OF THE DISCLOSED TECHNIQUE

The disclosed technique relates to search engines, in general, and to methods for implementing a medical search engine using a semantic analysis of the search query of a user and user feedback, in particular.

### BACKGROUND OF THE DISCLOSED TECHNIQUE

Medical search engines relate to internet based search engines that aid users in finding medical information on the World Wide Web (herein abbreviated WWW). This information can be in the form of web pages, online journals and articles, forums, chat groups, online communities and databases that relate to the medical field. It is noted that medical search engines can also be referred to as health search engines, as medicine refers to the art and science of dealing with health maintenance and the prevention, alleviation or cure of disease. It is also noted that the medical field does not refer to just modern medicine but includes the fields of complementary and alternative medicine as well, such as herbalism, acupuncture, chiropractic, yoga, biofeedback, homeopathy and the like. Many such search engines are currently known in the art such as OmniMedicalSearch.com, WebMD, Healthline, Healia, revolutionhealth, Medstory and Yahoo! Health. In general, these medical search engines enable a user to enter a search query, join an online community related to health issues, view blogs about medical issues, find doctors, search medical journals, view clinical trial results, and the like.

Specific methods for implementing search engines using user feedback are also known in the art. U.S. Pat. No. 6,829,599 to Chidlovskii, entitled “System and method for improving answer relevance in meta-search engines” is directed towards a method and apparatus for improving the search results from a meta-search engine that queries information sources containing document collections. Initially a query is received containing user selected keywords and user selected operators. The user selected operators define relationships between the user selected keywords. A set of information sources is identified to be interrogated using the query by performing one of: (a) receiving a set of user selected information sources, (b) automatically identifying a set of information sources, and (c) performing a combination of (a) and (b). The set of information sources identifies two or more information sources. At least one of the user selected operators of the query that is not supported by one of the information sources in the set of information sources is translated to an alternate operator that is supported by the one of the information sources in the set of information sources. A selected one of the translated queries and the query is submitted to each information source in the set of information sources. Answers are received from each information source for the query submitted. Each set of answers received from each information source that satisfy one of the translated queries is filtered by removing the answers that do not satisfy the query. For each filtered set of answers, a subsumption ratio of the number of filtered answers that satisfy the query to the number of answers that satisfy the translated query is computed. Each computed subsumption ratio is used to perform one of: (d) reformulating a translated query; (e) modifying information sources in the set of information sources automatically identified at (b); and (f) performing a combination of (d) and (e). The subsumption ratio is used to improve the accuracy of subsequent queries submitted by the user to the meta-search engine.

US Patent Application No. 2004/0177081 to Dresden, entitled “Neural-based internet search engine with fuzzy and learning processes implemented at multiple levels” is directed towards a method and system for improving the capacity and trainability of a neural network for computing a relevant search result based on a large set of search criteria. The search criteria are processed in a neural network, thereby enabling the system of Dresden to process information that would normally be too computationally complex to resolve. In particular, specific rules and fuzzy logic applications may be applied at several different levels to reduce the search and computing time. For example, a fuzzy neurode implements two complementary technologies at the lowest (input) level and may prevent the processing of massive amounts of irrelevant information at the computational (output) level. The adaptive genetic components may detect particular successful or unsuccessful searching configurations of the neural network and combine with other searching configurations where similar patterns have been detected. Finally, fuzzy logic and computation rules based on prior search results, user and situational data and manual or automated feedback mechanisms serve to teach the intelligence components of the system more efficient and accurate searching mechanisms. Learning from human and machine feedback is used to adjust and recombine the rules to improve accuracy for future searches as well as reduce computation time.

US Patent Application No. 2005/0210024 to Hurst-Hiller et al., entitled “Search system using user behavior data” is directed towards a search mechanism wherein context-based user behavior data is collected. This data includes, for a given query, user feedback (implicit and explicit) on the query and context information on the query. This information can be used, for example, to evaluate a search mechanism or to check a relevance model. This context-based user behavior data may include user information. In one embodiment, explicit feedback is requested from the user except when the user requests a pause in explicit feedback requests, or only periodically, in order to reach a target value for requests for explicit feedback. The explicit feedback may include feedback concerning results not visited, and concerning non-standard results. In another embodiment, implicit feedback data is collected, which includes whether a re-query was performed by the user, what the dwell and click time on the results page was, what the position of results clicked was (absolute position and page position), whether additional results were requested by the user (e.g. by clicking “next” for a next set of results), and destination page dwell time, page size or page actions.

US Patent Application No. 2006/0248057 to Jacobs et al., entitled “Systems and methods for discovery of data that needs improving or authored using user search results diagnostics” is directed towards a method for evaluating a search mechanism or a relevance model by using session level and result level diagnostics based on user behavior during a search session with respect to queries entered and user responses to result lists. Tracking occurs when content desired by a user exists, but is not returned in a search result list, when a query is made by the user with intent to find the desired content, when content desired by the user does not exist, when content desired by a user exists, but is not recognized by the user in a result list or is too low in a result list. A user's intent and search context is also taken into consideration when performing search mechanism diagnostics. The tracking comprises determining whether the user has accepted a search result within the session. Also, the results of the analyzing may be ordered by how often the content is identified as that which is tracked according to certain criteria.

US Patent Application No. 2007/0106659 to Lu et al., entitled “Search engine that applies feedback from users to improve search results” is directed towards a method and system for ranking results returned by a search engine. According to the method of Lu et al., a formula having variables and parameters is determined, wherein the formula is for computing a relevance score for a document and a search query. The document is ranked based on the relevance score. In general, determining the formula comprises tuning the parameters based on user input, wherein the parameters are determined using a machine learning technique, such as one that includes a form of statistical classification. The formula is derived from any one or more features of the document such as a tag, a term within the document, a location of a term within the document, a structure of the document, a link to the document, a position of the document in a search results list, and a number of times the document has been accessed from a search results list, term scores, section information, link structures, anchor text, and summaries. Alternatively, or additionally, the features include a user representation, a time of a user input, blocking, a user identifier, or a user rating of the document. In one embodiment, the formula corresponds to a user model and a group model. The user model is for determining a relevance score of the document and a search query for a user, whereas the group model is for determining a relevance score of the document and a search query for a group of users. The method of Lu et al. further comprises comparing the user model to the group model to determine a bias toward the document.

### SUMMARY OF THE PRESENT DISCLOSED TECHNIQUE

It is an object of the disclosed technique to provide a novel method and system for implementing a medical search engine wherein user feedback to returned search results is used to enhance the quality of the returned search results and a user's medical search query is enhanced by parsing the medical search query semantically using a medical ontology, which overcomes the disadvantages of the prior art.

In accordance with the disclosed technique, there is thus provided a method for enhancing the performance of a medical search engine. The method includes the procedures of generating an inverted index of medical related documents, receiving a medical search query from a user and expanding and augmenting the received medical search query, thereby generating an enhanced medical search query. The method also includes the procedures of retrieving all the medical related documents in the inverted index which are relevant to the enhanced medical search query, ranking the retrieved medical related documents according to a master expression and presenting the ranked retrieved medical related documents to the user. The method further includes the procedure of receiving at least one user feedback response from the user to a respective one of the ranked retrieved medical related documents. For each received user feedback response, at least one feature of the respective one of the ranked retrieved medical related documents is evaluated and stored. In addition, the master expression is modified based on the received user feedback response using at least one machine learning algorithm.

According to another aspect of the disclosed technique, there is thus provided a method for enhancing the performance of a medical search engine. The method includes the procedures of generating an inverted index of medical related documents, receiving a medical search query from a user and classifying the medical search query according to at least one subject. The method also includes the procedures of expanding and augmenting the received medical search query according to the subject, thereby generating a subject classified enhanced medical search query and retrieving all the medical related documents in the inverted index which are relevant to the subject classified enhanced medical search query. The method further includes the procedures of ranking the retrieved medical related documents according to a master expression, the master expression being specific to the subject. In addition, the method includes the procedures of presenting the ranked retrieved medical related documents to the user and receiving at least one user feedback response from the user to a respective one of the ranked retrieved medical related documents. For each received user feedback response, at least one feature of the respective one of the ranked retrieved medical related documents is evaluated and stored, and based on the received user feedback response, the master expression is modified using at least one machine learning algorithm.

According to a further aspect of the disclosed technique, there is thus provided a method for enhancing the performance of a medical search engine. The method includes the procedures of generating an inverted index of medical related documents, receiving a login from a user, the login generating a user profile and receiving a medical search query from the user. The method also includes the procedures of expanding and augmenting the received medical search query, thereby generating an enhanced medical search query, retrieving all the medical related documents in the inverted index which are relevant to the enhanced medical search query and ranking the retrieved medical related documents according to a master expression, the master expression being specific to the user profile. The method further includes the procedures of presenting the ranked retrieved medical related documents to the user, receiving at least one user feedback response from the user to a respective one of the ranked retrieved medical related documents and storing the received user feedback response from the user in the user profile. For each stored received user feedback response, at least one feature of the respective one of the ranked retrieved medical related documents is evaluated and stored. Based on the stored received user feedback response, the master expression is modified using at least one machine learning algorithm.

According to another aspect of the disclosed technique, there is thus provided a method for enhancing a user's medical search query based on semantic analysis. The method includes the procedures of receiving a medical search query from a user and parsing all terms in the medical search query based on a medical ontology according to predefined semantic types. The method also includes the procedures of expanding each parsed term in the medical search query based on the medical ontology, thereby generating a set of expanded terms and augmenting the set of expanded terms according to a rule based system using a set of weighted semantic features thereby generating an augmented set of expanded terms. The method further includes the procedure of concatenating the augmented set of expanded terms into an enhanced medical search query according to the rule based system.

### BRIEF DESCRIPTION OF THE DRAWINGS

The disclosed technique will be understood and appreciated more fully from the following detailed description taken in conjunction with the drawings in which:

FIG. 1 is a schematic illustration showing a method for implementing a medical search engine using user feedback, operative in accordance with an embodiment of the disclosed technique;

FIG. 2 is a schematic illustration of an interface of a medical search engine, constructed and operative in accordance with another embodiment of the disclosed technique; and

FIG. 3 is a schematic illustration showing a method for enhancing a user's medical search query, operative in accordance with a further embodiment of the disclosed technique.

### DETAILED DESCRIPTION OF THE EMBODIMENTS

The disclosed technique overcomes the disadvantages of the prior art by providing a system and a method for implementing a medical search engine wherein user feedback to returned search results is used to enhance the quality of the returned search results. User feedback is analyzed using machine learning algorithms to determine weighted features which correlate with higher levels of confidence in returning better quality search results. In addition, the disclosed technique provides for a method for enhancing a user's medical search query by parsing the medical search query semantically using a medical ontology. The parsed medical search query is rewritten in a form which better represents the user's medical search query.

In general, throughout the specification, the term medical search engine will be used to refer to an internet-based search engine which provides users information related to the medical and/or health fields. As mentioned above, such information can be in the form of online journals, online communities, chat groups, forums, web sites, web pages and the like. Also, medical search engines can be referred to as health search engines. In addition, the term medical search query will be used to refer to any type of query submitted to a medical search engine. Medical search queries can be individual words, questions or even whole paragraphs. In general, search engines function by generating what is known in the art as an inverted index of documents accessible on the World Wide Web (herein abbreviated WWW). For each document in the inverted index, the inverted index may include various features, or properties, of the document, such as its title, its abstract, the number of other documents on the WWW which link to that document, and the like. Each document in the inverted index, including its features, is generally represented as a vector of terms, with the index representing a matrix of vectors. The location where these document features are stored is a matter of technical implementation, as they may reside within the index, or they may be stored in another location, such as a database. In general, features of the documents in the inverted index are accessible in real-time during run time, when the inverted index is searched. Search engines use the inverted index to implement a searching technique known as term frequency-inverse document frequency, which is commonly abbreviated TF-IDF in the art. The TF-IDF searching technique is used to perform a substantially real-time comparison between a user's search query and all the documents in the inverted index. The TD-IDF searching technique is substantially a technique for comparing the similarity between vectors. When a user submits a search query to the search engine, the search query is converted into a vector of terms. The search engine then uses the TF-IDF searching technique to compare the search query of the user, as represented by a vector of terms, t the matrix of vectors of terms in the inverted index, where each vector in the matrix represents a document in the inverted index. The TF-IDF searching technique determines how similar the vector of terms, representing the search query of the user, is to the vectors in the matrix of the inverted index. Each vector in the matrix is then assigned a similarity score which indicates how similar a particular vector is to the vector representing the user's search query. Each document in the inverted index is then ranked based on its similarity score. As the inverted index includes a set of features for each document in the inverted index, the similarity score is substantially a technique for ranking documents according to the set, or a subset, of features stored in the inverted index. State of the art search engines generally use the TF-IDF searching technique for ranking documents. The ranking according to a set of features, i.e. the similarity score, is a measure of how relevant the document is to the search query submitted. In theory, the higher the relevance of the document, the more relevant the document is supposed to be to the user based on the user's search query. The ranked documents are then returned to the user in the form of a list, known as the search results, with the documents usually appearing in descending order of rank. Throughout the specification the term document is used to refer to information returned by the medical search engine. In the art, the term “document” usually refers to a web page. The disclosed technique is described in reference to documents which are returned by the medical search engine. Such documents are not limited to web pages but can include chat groups, forums, discussions, online communities and other manners in which information is presented over the WWW.

In general, the performance of a search engine, or in other words, the quality of the search results, is a measure of how satisfied a user is with the search results returned based on the search query submitted to the search engine. If the information the user is looking for is returned in the first few results of the search results, it can be said that the search engine returns high quality search results, or has a high precision. In the art, the term precision is used as a measure of the relevance of the search results. The precision of a search engine is determined by computing the proportion of relevant search results returned by the search engine, where relevance is based on a predefined benchmark of an optimal set of search results, to all the search results returned by the search engine. In the case of a very large number of returned search results, it is common practice to compute the precision of the returned search results within a predetermined number of search results that were returned and ranked by the search engine, such as the top ten, twenty or one hundred returned search results. In the art, another measure of the performance of a search engine is its recall. The recall of a search engine is determined by computing the proportion of search results that were retrieved by the search engine from a predetermined benchmark set of relevant search results. Search engines in general attempt to enhance both precision and recall, although in practice, there is an inverse correlation, or trade-off, between precision and recall. Returning search results with a high recall usually implies a decreased precision (i.e., reduced proportion of relevant results) and vice versa. In the case of search engines designed to search for documents on the WWW, precision is considered the main indicator of quality search results by both workers skilled in the art and end users of search engines, since recall is, in general, almost impossible to determine given the vast number of potentially relevant documents. In addition, it is typically not the intent of the user to receive all relevant search results.

If the information the user is looking for is ranked at the 130^{th} position of the search results (i.e., 130^{th} on the retrieved list of documents), the user will have to scroll through many pages of search results until they find what they are looking for. Such a search engine can be said to return low quality search results, or has a low precision. The quality of the search results depends on two major aspects, with the first being how the search engine actually executes the search, i.e. which features are used by the search engine to determine the rank of the documents in its inverted index. Another way of saying this is which document features are stored in the inverted index and used in determining a similarity score between the user's search query and the documents in the inverted index. The second is the phrasing of the search query of the user which influences the search results returned by the search engine. Whereas the first aspect can be controlled and planned in a search engine, the second aspect is very unpredictable as general users may not know the best way of phrasing their search query to find the information they are looking for. The disclosed technique provides for a system and a method for implementing a medical search engine which uses user feedback to determine which features should be used by the search engine to increase its performance. The disclosed technique also provides for a system and a method for enhancing the search query of a user such that higher quality search results are returned to the user based on their search query. The enhancement of the user's search query includes an expansion as well as an augmentation of the user's search query.

It is noted that the medical and health fields are different in certain respects regarding the internet and the WWW as compared to other fields of information. In general, large amounts of medical information is available on the WWW, large numbers of users search the WWW everyday for medical information and many of those users give feedback, if enabled to, about the medical information they find. It is noted that a large percentage of the users who search the WWW for medical information are not medical or health professionals, i.e. they may not be familiar with all the terminology used to describe medical or health issues. In addition, the medical and health fields include many complex terms, which each may have a plurality of synonyms, which can make phrasing a search query in a manner that search engines return highly relevant search results difficult. The medical search engine of the disclosed technique takes advantage of these differences in the medical and health fields as they relate to the internet and the WWW to increase the performance of a medical search engine and to enhance the medical search queries of general users such that more relevant search results are returned.

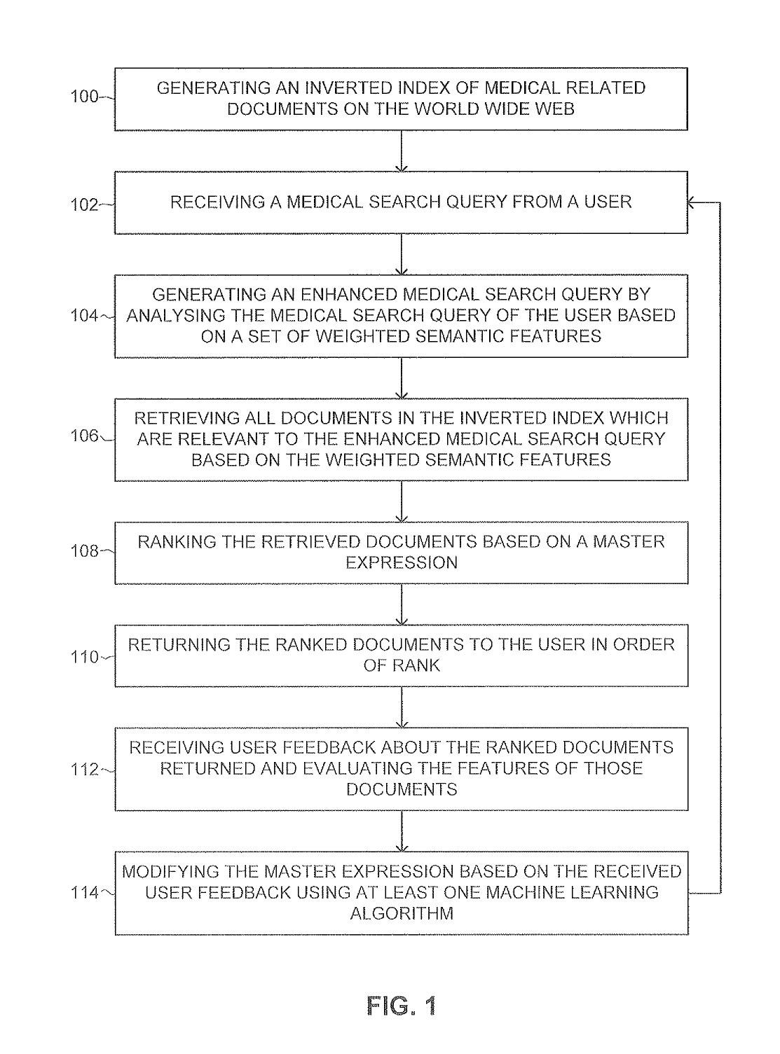

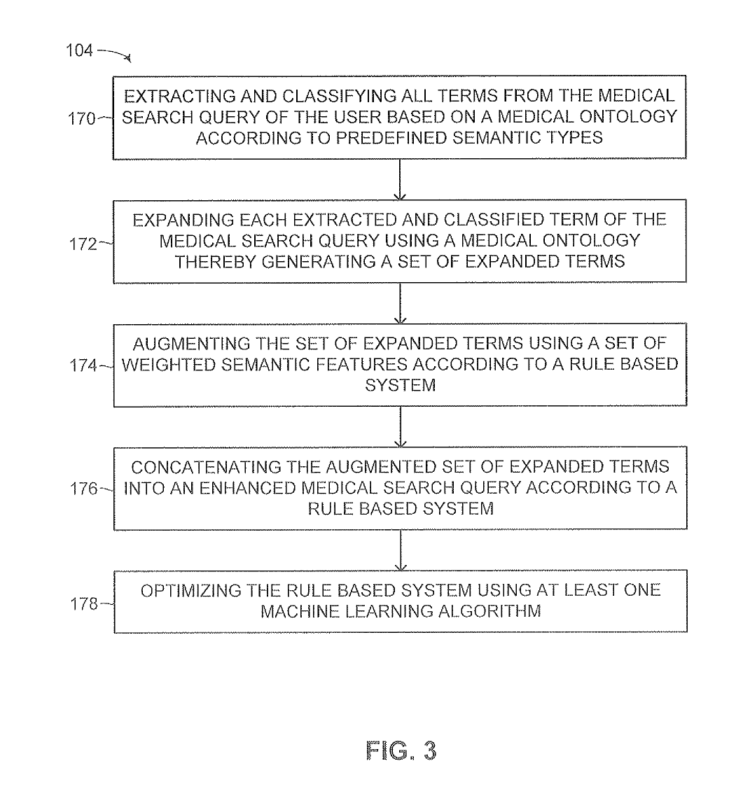

Reference is now made to FIG. 1, which is a schematic illustration of a method for implementing a medical search engine using user feedback, operative in accordance with an embodiment of the disclosed technique. As mentioned above, a medical search engine relates to a search engine wherein users of the search engine are searching for medical-related or health-related information in particular. For example, a user entering a search query such as “red eye” in a medical search engine can be assumed to be looking for documents related to conjunctivitis and not to the red-eye effect in photography. This is explained in greater detail below in FIG. 3. In procedure 100, an inverted index of medical related documents on the WWW is generated. As the documents available on the WWW are continually changing, since new documents are added every day and older documents may be removed or changed, the inverted index of documents requires constant updating. As such, procedure 100 is executed at reasonable time intervals, where reasonable is defined as being dependent on the computing power available. Since the WWW comprises over a billion documents, indexing can take a significant amount of time, ranging from a few hours to a few weeks. For example, procedure 100 may be executed every day, given sufficient computing power, every week or every month. In one embodiment of the disclosed technique, the inverted index generated is derived from a directory of medical related websites accessible on the WWW. Features of the medical related websites may be stored in a database which is accessible by the inverted index. In this embodiment of the disclosed technique, the directory is maintained manually and updated at regular intervals using known techniques for locating medical related websites on the WWW.

For example, one technique would include the following procedures. In a first procedure, a small group of websites (e.g., a few thousand websites), classified as containing medical content, is retrieved from a well known online health directory, such as www.dmoz.org. In a second procedure, the retrieved websites are reviewed manually for medical content. Only websites containing relevant medical content are stored in a directory, whereas other websites are discarded. In a third procedure, the stored websites are then crawled using a web crawler. During the crawling process, a record is stored of every website that is referenced from the crawled websites and is not already stored in the directory. In a fourth procedure, after all the websites in the database have been crawled, a list is generated of websites that have many references (i.e., popular websites) and are not stored in the directory. In a fifth procedure, these websites having many references and not stored in the directory are tagged as ‘suspected as containing medical content’ since many websites containing medical content refer to them. In a sixth procedure, the ‘suspected as containing medical content’ websites are reviewed manually to decide whether they should be included in the directory or not. In an alternative to the sixth procedure, automatic tests can be run on the ‘suspected as containing medical content’ websites to determine whether they should be included in the directory or not. Automatic tests may include, for example, searching for medical terms within the website names. The directory generated from these procedures is the directory of medical related websites accessible on the WWW from which the generated inverted index is derived.

In another embodiment of the disclosed technique, the inverted index generated is derived from all documents accessible on the WWW but only includes documents which contain medical and/or health related information. Features of documents in the inverted index may be stored in a database which is accessible to the inverted index. In this embodiment of the disclosed technique, indexing can be executed by filtering out documents which do not contain medical words or terms specified in a list of such words or terms. Such lists can be constructed from medical dictionaries or from medical ontologies, such as the Unified Medical Language System (herein abbreviated UMLS). By way of example, the UMLS will be used throughout the description to describe the disclosed technique, yet it is noted that other medical dictionaries and medical ontologies can be used with the disclosed technique for constructing such lists. The inverted index generated in procedure 100 is used by the medical search engine of the disclosed technique to return search results to a user.

The inverted index in procedure 100 may include a set of features for each document in the inverted index. As explained below, such features may be features which are correlated with returning more precise search results based on a user's search query according to the disclosed technique. In this respect, documents which are indexed in the inverted index are indexed in a manner which simplifies their retrieval, as specific features of documents are evaluated to determine their rank (see procedure 108 below) and documents are indexed according to those specific features. In addition, the inverted index may be generated as an N-dimensional matrix, where each document listed in the inverted index is not listed as a two dimensional (2D) vector but an N-dimensional vector, where N is a natural number. In general, each vector representing a document may include elements which represent words which occur in the document. The additional dimensions for each vector may be used for storing synonyms and abbreviations of the words, as well as related terms or phrases of the words which occur in the document and which have medical significance. A word can be defined as medically significant if it appears in a medical dictionary or can be found in a medical ontology such as the UMLS. By way of example, the UMLS will be used throughout the description to describe the disclosed technique, yet it is noted that other medical dictionaries and medical ontologies can be used with the disclosed technique for defining if a word is medically significant or not. For example, if a document contains the words “broken bone” and “pain” then the inverted index may store the words “broken bone” and “pain,” as well as how many times they appear in the document (known in the art as the term frequency), as separate elements in the vector representing the document. In addition, another dimension of the vector may be used for storing synonyms and abbreviations for these words, such as “bone fracture” and “FX” for the element “broken bone” and “discomfort,” “injury” and “agony” for the element “pain.”

In procedure 102, a medical search query is submitted by a user to the medical search engine of the disclosed technique, which in turn receives the medical search query. It is noted that after procedure 100 has been executed for the first time, i.e. an initial inverted index of medical related documents on the WWW has been generated, procedures 100 and 102 can be executed simultaneously. In procedure 104, the medical search query of the user is enhanced by analyzing the medical search query of the user based on a set of weighted semantic features. This is explained in greater detail in FIG. 3. It is noted that this procedure is unlike a known technique in the art commonly referred to as query expansion. In procedure 104, the search query of the user is expanded and also augmented, as explained below in FIG. 3, and is hence referred to as an enhancement of the medical search query. In general, a medical ontology, such as the UMLS, is used to expand and refine the medical search query of the user such that the medical search engine better “understands” the nature of the medical search query. It is noted that medical ontologies may be linked with medical dictionaries. By way of example, the UMLS will be used throughout the description to describe the disclosed technique, yet it is noted that other medical dictionaries and medical ontologies can be used with the disclosed technique for expanding and refining the medical search query of the user. Such medical dictionaries and medical ontologies can include proprietary lists of terms, abbreviations, medical prefixes, medical suffixes and the like. In addition, weighted semantic features are also used to augment the various terms in the medical search query such that the medical search engine better “understands” the nature of the medical search query. To a certain degree, the expansion and augmentation of the user's medical search query is executed to disambiguate the user's medical search query. As described below in FIG. 3, refining the medical search query can enhance the “understanding” of the medical search query by classifying the medical search query according to an ontology. For example, the medical search query “I have an enlarged heart” does not specify what type of information the user is searching for. The user may want to know what the symptoms are of an enlarged heart, if other people suffer from such a condition, if there are cures for such a condition, where can a doctor be found that specializes in treating this condition and the like. As the user only wrote “I have an enlarged heart,” not specifying if they were looking for general information, known treatments, alternative medical treatments and the like, a prior art search engine would use that medical search query as is to search its index of documents to return search results to the user. In procedure 104, this medical search query is enhanced to a medical search query such as “enlarged heart cardiomegaly dilated cardiomyopathy DCM” which specifies the condition of an enlarged heart in medical terms, including known medical abbreviations (e.g., DCM). As mentioned above, it is an assumption of the disclosed technique that user's of a medical search engine submit search queries which have medical relevance. Given this assumption, the medical search query of the user in procedure 104 can be analyzed semantically based on a medical ontology.

In procedure 106, the enhanced medical search query is used by the medical search engine to search through the inverted index of documents generated in procedure 100 and to retrieve documents which are relevant to the enhanced medical search query. In general, any retrieval method known to the worker skilled in the art can be used to retrieve the documents in the inverted index which are relevant to the enhanced medical search query. For example, each document in the inverted index can be assigned a relevance score based on the enhanced medical search query. Relevancy may be measured by a predetermined minimal relevance score, such as 0.5, where relevance scores range from 0 (not relevant) to 1 (relevant). As an example, if the TF-IDF searching technique is used, then the relevance score would be the similarity score. As mentioned above, the similarity score is a measure of how similar a user's search query is to documents in an inverted index based on a set of features, such as the term frequency of the terms in the user's search query in a particular document. The relevance score is a function of the weighted semantic features of procedure 104, as described below. It is noted that although documents are retrieved in procedure 106, such documents are not presented to the user as search results in this procedure. The retrieved documents are only those documents which received a relevance score above the predetermined minimal relevance score. In addition, it is noted that the retrieved documents are not ranked in this procedure. The searching and retrieving techniques used in procedure 106 are only used to determine which documents in the inverted index are relevant to the enhanced search query of the user. The ranking of the documents is executed in procedure 108, as explained below. As explained below in FIG. 3, each of the terms of the enhanced medical search query in procedure 104 can be assigned a particular weight, based on semantic features of each of the terms, which determines which documents in the inverted index of documents of procedure 100 are retrieved. These weights substantially determine the relevance score of the documents in the inverted index and can also influence the rank of the documents as described in procedure 108.

In procedure 108, the retrieved documents are ranked according to a master expression. The master expression includes a set of weighted features, one of which is the measure of how relevant a particular document is based on the user's enhanced medical search query, as determined in procedure 106. Various structures can be used to embody the master expression, as is known in the art. For example, the master expression can be embodied as a decision tree. This procedure is executed in real time. The features are aspects of the documents retrieved and can be related to the medical search query or unrelated to the medical search query. Examples of features unrelated to the medical search query are the font size of the heading of the document, the length in words of the body of the document, the background color of the document, the number of other documents on the WWW that point to that document, known in the art as backlinks, the nesting level of the Uniform Resource Locator (herein abbreviated URL) of the document on the WWW and the like. Examples of features related to the medical search query are the number of times a particular term in the medical search query appears in the body of the document, known in the art as the term frequency, if the terms of the medical search query appear in the meta-content of the document, such as the document's link tag and title tag, how many times all the terms in the medical search query appear in a single sentence in the document, the TF-IDF of terms in the medical search query and the like. Such features are known to the workers skilled in the art.

Before procedure 108 is executed for the first time, a list of a plurality of features, for example, between 100-200 features, is generated manually. Each feature in the list is assigned a particular weight, for example, a decimal number between 0 and 1. The weights represent the importance of the feature as described below. In procedure 108, each document is assigned a rank by evaluating each weighted feature in the document and assigning a score for each weighted feature in the document. As each weighted feature assigns a number, i.e. a score, to the document being evaluated, the rank represents the combination of numbers assigned to the document. For example, the combination may be the product of the numbers assigned to the document, or the sum of the numbers assigned to the document. As explained below in more detail, a higher rank represents a better statistical prediction that the document will generate positive user feedback. This is distinct from a higher relevance score, as explained above, which represents how relevant a document is to the user's medical search query based on a set of weighted semantic features. As mentioned, the relevance score of a document may be used as one of the features in the master expression used in procedure 108 for ranking the document. As an example, the length of the document may have a low weight, such as 0.1, whereas the font color of the title may have a high weight, such as 0.9. When a document is evaluated based on the weighted features, the length of the document in words may be multiplied by 0.1 to determine the length evaluation, or a length score, of the document, whereas the document may receive a font color of the title evaluation, or font color of title score, of 0.9 if the font color is blue, and 0 if the font color is not blue. It is noted that the assigned weights can also be negative if the scores' of the features are added. As explained below in procedure 114, the weighted features are grouped into a master expression which links all the features and their weights together.

It is as assumption of the disclosed technique that particular features of documents accessible on the WWW determine whether users will be satisfied with the search results returned from the medical search engine of the disclosed technique. In other words, it is assumed that a consensus can be determined among users about which features in a document lead to more relevant search results. Initially, the features which are evaluated and their respective weights represent features which theoretically determine the satisfaction level of users to the search results returned. The features, and their respective weights, which are manually selected and assigned before procedure 108 is executed for the first time may be determined based on test trials of users which are designed to determine which features influence user satisfaction with the search results returned from their medical search query. In this respect, features which appear to have a greater influence in determining user satisfaction can be assigned a larger weight whereas features appearing to having lesser influence can be assigned a smaller weight. Features which have a negative influence, i.e. features which appear to lead to user dissatisfaction, can be assigned negative weights if the scores' of features are added, or very small positive numbers if the scores' of the features are multiplied. As described below in procedure 114, after procedure 108 is executed for the first time, the features used to rank the document, as well as their weights, are modified according to the disclosed technique in an automated manner.

It is also noted that before procedure 108 is executed for the first time, a preprocessing procedure (not shown) of feature selection is executed on a training set of documents. The procedure of feature selection uses known special algorithms to identify and recognize features of documents which may affect the relevance of a particular document to a given general search query. Examples of these special algorithms can include the following approaches: exhaustive, best first, simulated annealing, genetic algorithm, greedy forward selection, greedy hill climbing and greedy backward elimination. These special algorithms run through a given training set of documents and attempt to identify features in which a change in their value makes a significant difference in the relevance of a particular document to a given general search query. Each feature which is identified is assigned a type of rank which indicates the contribution of the feature to the relevance of a particular document to a given general search query. The identified features substantially form the list of a plurality of features mentioned above, with each feature being assigned an initial weight based on its rank. In general, this preprocessing procedure is executed once, meaning the features included in the master expression are selected from the list of features determined in the preprocessing procedure. As mentioned above, before procedure 108 is executed for the first time, a list of a plurality of features, for example, between 100-200 features, is generated manually. After the preprocessing procedure of feature selection, the number of features in the list of features may be reduced to a list of the most important features which may affect the relevance of a particular document to a given general search query. This list may include, for example, between 5-10 features.

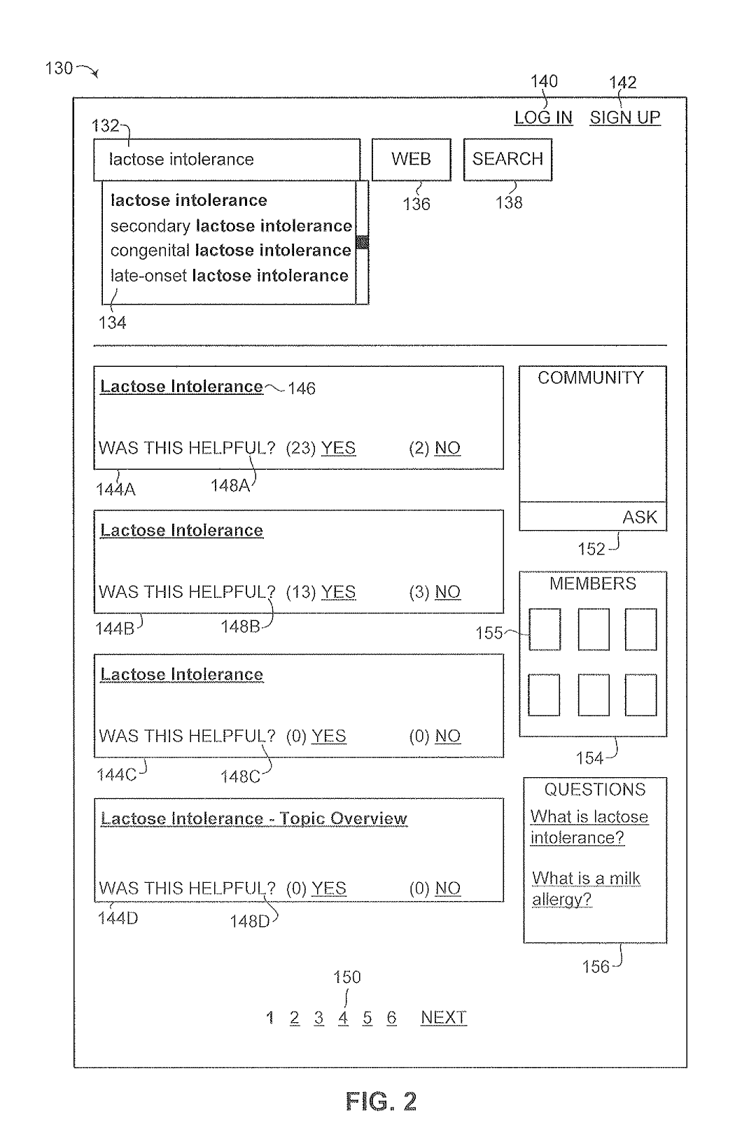

In procedure 110, the documents retrieved and ranked in procedure 108 are presented to a user as search results to their medical search query in descending order of rank. The documents can be presented using different interface formats, as is known in the art. For example, each document listed may be listed with its title, its abstract and the URL of the document. In addition, for each document listing, a user feedback mechanism is provided by which a user feedback response can be received, as in procedure 112. In one embodiment of the disclosed technique, the user feedback mechanism may be in the form of a dichotomous question, such as “Was this website helpful?” or “Did you find this helpful?” in which a user is given two possible choices as an answer, such as “Yes/No,” “Thumbs Up/Thumbs Down” or “Useful/Not Useful.” In this embodiment, choices such as “Yes,” “Thumbs Up” and “Useful” can be referred to as positive feedback whereas choices such “No,” “Thumbs Down” and “Not Useful” can be referred to as negative feedback. In another embodiment of the disclosed technique, the user feedback mechanism may be in the form of a question in which the user is asked to rank the usefulness or helpfulness of the document based on a given scale. For example, the question may be “How useful was this web site?” with the user given the possibility of five choices in terms of an answer ranging from “Very useful” to “Not useful at all.” An example interface according to the disclosed technique is shown below in FIG. 2.

In another embodiment of the disclosed technique, a user feedback response is received indirectly by tracking the user's behavior vis-à-vis the search results returned. For example, the number of users that open a specific search result can be counted and tallied over time. In such an embodiment, a preview of the documents returned as search results, such as a small image of the start page of the document, may be provided to the user. This is to increase user awareness of each document in the search results before the user's choice is made as to which document to open up. Another example is the case where a user opens a first search result and then continues to open additional search results until a final search result is opened and the user spends a predetermined amount of time viewing the document which the final search result points to. In this case, all the search results opened up may be tagged as being “not useful” except for the final one, which may be tagged as “useful” since the user was apparently not satisfied with the initial search results accessed. Other methods for receiving a user feedback response indirectly by tracking a user's behavior vis-à-vis the search results returned are known in the art.

In procedure 112, user feedback from the ranked documents returned is received and features of those documents are also evaluated and stored. Depending on how the inverted index of procedure 100 is generated, the features of the ranked documents to which user feedback was received may have already been stored in the inverted index of procedure 100 when the inverted index was generated. In general, a portion of the features of the ranked documents are stored in the inverted index of procedure 100 when the inverted index is generated, whereas the other portion of the features of the ranked documents are evaluated and stored in procedure 112 when a user provides user feedback to a particular document. It is noted that in this procedure, the user feedback received is anonymous and is not received based on a user's profile. In other words, to provide feedback, the user does not need to log onto the medical search engine to receive a user ID such that their feedback can be tracked personally. In addition, it is not expected that each user of the medical search engine of the disclosed technique will provide feedback to the search results returned by the medical search engine, as it is assumed that on average, some users will provide feedback and others will not. Users can provide feedback as described above via a user feedback mechanism. In this procedure, users can provide feedback about a document either before they have viewed the document, or after they have viewed the document. Once a document has been viewed, user feedback can be provided about the document in various ways which are dependent on the user interface implementation of the medical search engine. For example, to provide feedback to a document a user has viewed, the user may need to return to the search results page provided by the medical search engine of the disclosed technique to use the feedback mechanism. In another embodiment of the disclosed technique, the search results page may include a full copy or a good preview of each document returned. In this embodiment, the user can provide feedback to a viewed document without having to open up the document and then returning to the search results page to provide feedback. User feedback to the document can be stored and presented to a future user. For example, the user feedback mechanism may provide a statistic on the number or percentage of previous users who have found a particular document helpful or not helpful. As explained in procedure 114, user feedback is used to determine a consensus about relevant features of a document that generate more relevant search results. It is noted that an initial consensus can be determined even with a minimal number of user feedback responses, such as two or three. One user feedback response can be enough to establish a consensus in cases where the user is sufficiently reliable or is an expert in the domain of the document returned. In addition, when a user feedback response is received about a particular document, the medical search engine of the disclosed technique evaluates all the features of the document as specified in the set of features and weights used in procedure 108. The value for each feature which is evaluated and stored is used in procedure 114, as described below. It is noted that fraud detection techniques and algorithms known in the art may be used in procedure 112 to determine whether user feedback responses received are fraudulent or not. User feedback responses which are fraudulent are discarded in procedure 112, whereas user feedback responses which are not fraudulent are stored in procedure 112. Fraudulent user feedback responses can include positive user feedback responses for search results which the user was not satisfied with or vice-versa.

In procedure 114, the user feedback received in procedure 112 is used to modify the master expression using at least one machine learning algorithm. The machine learning algorithms used in procedure 114 can include any combination of known machine learning algorithms, such as the Naïve Bayesian Classifier, Support Vector Machine (herein abbreviated SVM) Learning, Logistic Regression and C4.5. In addition, meta-classifiers can be used which combine the results from different machine learning algorithms. In particular, the at least one machine learning algorithm should be functional in optimizing precision. Machine learning algorithms group a set of features together, with each feature being assigned a particular weight, into a master expression. In procedure 114, after feedback has been provided by a user about a document returned in the search results, the at least one machine learning algorithm used in the disclosed technique examines the features of the document for which feedback was provided for, which were evaluated and stored in procedure 112, as well as the current master expression linking all the features and their weights together. The at least one machine learning algorithm then determines if any of the weights should be modified or changed in the master expression.

For example, in procedure 114, the master expression initially used in procedure 108 for the first time may have assigned the feature ‘font size of heading’ a low weight. After receiving a plurality of user feedback responses, the machine learning algorithm may determine that the feature ‘font size of heading’ is strongly correlated to a user providing a positive feedback response regarding a document. The machine learning algorithm will then modify the weight of the feature ‘font size of heading’ and increase it such that it has more weight when a document is ranked. It is noted that the user feedback responses provided to the machine learning algorithm may also be weighted. For example, user feedback which is provided before a user has viewed a document may have a lower weight in influencing modifications to the weights and features in the master expression as opposed to user feedback which is provided after a user has viewed a document. In addition, the number of features used in the master expression may be significantly reduced over time if a large number of features appear to be uncorrelated, based on user feedback responses, with returning higher quality, more relevant search results. As mentioned above, the first time procedure 108 is executed, a manually generated set of features and weights, determined in a preprocessing procedure, are used which may include 100 to 200 features. After procedure 114 has been executed a plurality of times, the number of features in the master expression may be brought down to 10 or 20 such that documents ranked in procedure 108 can be ranked and presented to a user in real time. As procedure 114 is executed a plurality of times, the weights of the features included in the master expression are modified and varied. In general, the number of features in the master expression is not varied over time, although features in the master expression can be added or removed. It is also noted that the machine learning algorithms used in procedure 114 can be modified to increase the number of documents returned which have a high probability of receiving positive feedback from a user and decreasing the number of documents returned which have a high probability of receiving negative feedback from the user. In other words, the precision of the medical search engine can be increased by increasing the number of documents evaluated as false negatives and decreasing the number of documents evaluated as true positives to increase the performance of the medical search engine. The recall of the machine learning algorithm can be lowered in order to increase the quality and precision of the search results returned. The precision of the search results returned can also be increased by lowering the number of documents evaluated as false positives. False negatives refer to documents which are determined by a machine learning algorithm to be not relevant to the search query submitted (i.e. they have a high probability of receiving negative user feedback) when in fact they are (i.e. they have a high probability of receiving positive user feedback), whereas true positives refer to documents which are determined by the machine learning algorithm to be relevant to the search query submitted and which in fact are relevant.

It is noted that the user feedback received in procedure 112 is not used by the machine learning algorithms in procedure 114 to determine which documents are good or bad, i.e. satisfy or dissatisfy a user, as search results to a particular medical search query. For example, a higher percentage of positive user feedback about a document X relating to lactose intolerance as opposed to a lower percentage of positive feedback about a document Y relating to the same subject is not used in procedure 114 to determine that document X provides a better search result to a medical search query which includes the terms “lactose intolerance.” The user feedback in procedure 112 is used in procedure 114 to determine which features of a document in general are correlated with generating a higher statistical confidence in positive feedback from a user. In other words, the user feedback in procedure 112 is used to determine which features in a document in the inverted index of documents generated in procedure 100 will lead a user to submit positive feedback about that document. The user feedback is used to determine a consensus about relevant features in documents, wherein each positive user feedback response increases the statistical confidence in that consensus. After procedure 114 is executed, the method returns to procedure 102, wherein another medical search query is received from a user. It is noted that procedure 114 does not need to be executed after each medical search query is submitted to the medical search engine of the disclosed technique. For example, after procedure 110 is executed, procedure 112 may or may not be executed depending on whether the user provides feedback to the search results or not. Also, procedure 112 may be executed a while after procedure 110 is executed, as a user may only provide feedback to the document after the document has been viewed, which could be after a matter of seconds or after a couple of hours. In this respect, procedure 114, similar to procedure 100, may be executed at specific time intervals, for example, every hour, every four hours, once a day, once a week or once a month, depending on available computing power. It is also noted that in procedure 114, the master expression may be modified based on a change in the medical dictionary, or dictionaries, used as well as the medical ontology, or ontologies, used above in procedure 104. For example, if a new medical dictionary is linked to the medical ontology used in procedure 104, then the master expression may be modified based on the inclusion of the new medical dictionary in the medical ontology used to enhance the user's medical search query.

As an example of how the at least one machine learning algorithm of procedure 114 modifies the set of features and weights, reference is now made to Table 1, which shows an example matrix of data used as input to the at least one machine learning algorithm.

TABLE 1
Example matrix of data regarding documents to which
user feedback was provided used as input to a machine learning algorithm

| | | | | | | User |
|---|---|---|---|---|---|---|
| Document URL | F₁ | F₂ | F₃ | . . . | F_{N} | Feedback |
| http://www.site1.com | 1 | 1 | 259 | . . . | 1 | Positive |
| http://www.site2.com | 0 | 1 | 5042 | . . . | 0 | Negative |
| . . . | . . . | . . . | . . . | . . . | . . . | . . . |
| http://www.siteM.com | 0 | 0 | 3621 | . . . | 1 | Negative |

Table 1 shows a list of documents, the results of the evaluation as evaluated in procedure 112, of each of the features in the set of features used in procedure 108 for each of the documents listed as well as the user feedback response received in procedure 112 from those documents. In the art of machine learning, Table 1 is referred to as a training set, with each document being referred to as a sample. As shown in Table 1, features F range from 1 to N, where N is a positive natural number and the number of documents in the table range from 1 to M, where M is also a positive natural number. As can also be seen in the table, certain features can be evaluated as True or False, represented by digits such as “1” for True and “0” for false. Other features, such as the length of the body of the document in words, shown as feature 3 (F₃) above, can be evaluated as an actual number. Features such as the TF-IDF score of a document can be represented as real numbers. Recall that one of features F₁ to F_{N} is the relevancy score determined in procedure 106. The machine learning algorithm used in the disclosed technique can use a table like Table 1 as a training set to determine a correlation between each of features F₁ to F_{N} to a user feedback response of “Positive.” The correlation includes not just which features are correlated with a user feedback response of “Positive” but also the weights assigned to each feature. The weights can be referred to as coefficients depending on the type of machine learning algorithm used. As additional documents are added to Table 1, the machine learning algorithm reevaluates the correlation by adjusting the features as well as their respective weights to determine which set of features and respective weights correlates with the largest number of user feedback responses of “Positive.” As an increased number of samples to a training set improves the machine learning algorithm's “understanding” of the correlation between features and weights and an increase in receiving a positive user feedback, the number of samples in the training set used in the disclosed technique constantly increases as more users provide feedback to search results returned. In general, the training set used in procedure 114 for modifying the master expression is rebuilt every time procedure 114 is executed, using up-to-date runtime variables relating to each sample in the training set. New user feedback responses, which are determined not to be fraudulent in procedure 112, received since the previous time procedure 114 was executed, are added incrementally to the training set. For each new user feedback response added, the features of the document to which the user feedback response refers to is also added to the training set. Certain runtime variables of documents in the training set may be used to filter out samples which have a low confidence level in predicting which features of documents are correlated with receiving positive user feedback from a user's medical search query. For example, the runtime variable “click on link of result,” which states whether a user clicked on a link in the search results returned or not, can be used to determine which samples represent user feedback to documents in which the user did not view the document before submitting a user feedback response. Samples in which the runtime variable “click on link of result” is false may be removed from the training set.

It is noted that each time procedures 102 to 114 are executed, the performance of the medical search engine of the disclosed technique can be increased in a positive, monotonic manner, i.e. the performance can either remain the same or can increase, as the machine learning algorithms in procedure 114 are continually modifying the set of features and their respective weights. Each time procedure 108 is executed, the ranking of retrieved documents is based on a master expression, which includes a set of features and weights, which is learned in procedure 114 from all previous searches, rankings and user feedback. In this respect, the master expression which links all the features and their respective weights is dynamic and changes over time as users provide more feedback.

Procedures 102 to 114 can be executed on any type of medical search query. In another embodiment of the disclosed technique, in the case of a frequently asked medical search query, an alternative procedure to procedures 108 and 110 can be executed. A frequently asked medical search query is a medical search query which has been submitted to the medical search engine of the disclosed technique at least a particular number of times. For example, a frequently asked medical search query may be one which has been submitted to the medical search engine of the disclosed technique over 500,000 times. In general, the search results returned to any frequently asked medical search query have been ranked a plurality of times and have received a plurality of user feedback responses. In such a case, to increase efficiency, i.e. to lessen the amount of time required to return the search results to a user, instead of ranking all the documents retrieved in procedure 106 in procedure 108 and then returning the search results to the user in procedure 110, an alternative procedure to procedures 108 and 110 is executed. In this alternative procedure, the search results from the previous time the frequently asked medical search query was submitted are returned directly to the user. The method would then continue with procedure 112 in this embodiment.

The master expression used in procedure 108 and modified in procedure 114 is not specific for any type of medical search query, subject or user. In other words, the features and weights of the master expression are determined for documents on the WWW in general. In another embodiment of the disclosed technique, different master expressions can be determined and modified for different subjects. For example, a first master expression could be determined and modified for medical search queries which relate to the heart whereas a second master expression could be determined and modified for medical search queries which relate to the lungs. It is possible that a first set of features and respective weights exists for medical search queries relating to the heart, such as “heart disease,” “cholesterol and the heart,” “I have an enlarged heart,” “medications for heart disease” and the like, which will return search results that a user is more likely to give positive feedback to. It is also possible that a second set of features and respective weights exists for medical search queries relating to the lungs, such as “lung disease,” “I have asthma,” “Alternative treatments for emphysema,” “medications for lung disease” and the like, which will return search results that a user is more likely to give positive feedback to. In this embodiment of the disclosed technique, in an alternative to procedure 104, each medical search query is enhanced and also classified according to subject. In procedure 108, the retrieved documents are ranked according to a set of features and weights particular to the classified subject of the medical search query. In procedure 112, the received user feedback, as well as the evaluated features of the documents to which user feedback was provided for, is stored according to the classified subject of the medical search query. In procedure 114, the set of features and weights particular to the classified subject of the medical search query are modified based on the received user feedback of procedure 112 particular to the classified subject of the medical search query.

In a further embodiment of the disclosed technique, different master expressions can be determined and modified for different users. In this embodiment, a user is required to log into the medical search engine of the disclosed technique to generate a user profile. In procedures 108, the retrieved documents are ranked based on a set of features and weights particular to the user. In procedure 112, the user feedback provided by the user is stored in the profile of the user, along with the evaluated features of the documents to which user feedback was provided for. In procedure 114, the set of features and weights is modified according to the user feedback stored in the profile of the user in procedure 112. This is known in the art as personalization or segmentation.

Reference is now made to FIG. 2, which is a schematic illustration of an interface of a medical search engine, generally referenced 130, constructed and operative in accordance with another embodiment of the disclosed technique. Interface 130 includes a search field 130, a selectable autocomplete list 134, a search database list 136, a search button 138, a log in link 140, a sign up link 142, search results 144A, 144B, 144C and 144D, a search result title 146, user feedback mechanisms 148A, 148B, 148C and 148D, a page list selector 150, an online community interface 152, a chat interface 154, an online user link 155 and a questions interface 156. Search field 132 represents a field wherein a user can enter in a medical search query, such as “lactose intolerance” as shown in FIG. 2. Selectable autocomplete list 134 represents a list of predicted words or phrases the user may want to type in without having to actually type in the words or phrases completely. Selectable autocomplete list 134 may use a medical dictionary, such as SNOMED Clinical Terms, MeSH (an abbreviation for Medical Subject Headings), or a medical ontology such as the UMLS, to predict what the user may want to type in. As the dictionary or ontology used is medically based, selectable autocomplete list 134 includes terms which may be difficult for a general user to type in correctly and may include related terms which the general user may not have considered as relevant to their search query. Whereas a user may have typed “lactose intolerance” in search field 132, the user may not have thought of the terms “secondary” or “congenital” as modifiers to their medical search query as provided for by selectable autocomplete list 134. Terms in selectable autocomplete list 134 which match the terms in search field 132 are bolded. In this respect, selectable autocomplete list 134 searches canonically and not lexically. In other words, as a user types in a word in search field 132, a full text search of the word with wildcards is executed simultaneously in a medical dictionary, medical ontology or both, as mentioned above, to predict what the user wants to type in.

Search database list 136 enables a user to select what type or types of documents they wish to search. For example, in FIG. 2, search database list 136 is selected to “Web,” meaning the user wants to find web pages related to lactose intolerance. Other options in search database list 136 may include community, members, questions, forums and the like. For example, if the user selected “Community” then the user's search query would be used to search an index of documents which represent online communities. As mentioned above in FIG. 1, the method of FIG. 1 can be used to search any type of document available on the WWW, where a document represents accessible information in various forms. Using search database list 136, the user can specify which type of document they wish to search and find. Search button 138 is used by a user to execute a search once a medical search query has been entered in search field 132. Log in link 140 and sign up link 142 enable a user to create a profile, or to log into their profile once it has been generated, on the medical search engine. A user profile can be used by the user to join an online community coupled with the medical search engine. As mentioned above with reference to FIG. 1, in one embodiment of the disclosed technique, a user's profile can be used to store a specific set of features and weights which are modified based on the user's feedback responses to the various documents they view and provide feedback to. In this embodiment, where a master expression is generated and modified per user, a user must have a user profile on the medical search engine such that their medical search queries and user feedback responses can be tracked and stored.

Search results 144A, 144B, 144C and 144D represent the search results returned to the user based on the user's medical search query. As described above with reference to FIG. 1, the user's medical search query, such as “lactose intolerance” is enhanced in procedure 104 (FIG. 1) and is used to retrieve all documents in the inverted index of the search engine, procedure 106 (FIG. 1), which may be relevant to the enhanced medical search query. The retrieved documents are then ranked according to a set of features and weight (i.e. via a master expression), procedure 108 (FIG. 1), before being returned to the user in ranked order, as in procedure 110 (FIG. 1). Referring back to FIG. 2, search results 144A, 144B, 144C and 144D represent the search results returned to the user in ranked order as in procedure 110. It is noted that in FIG. 2, each search result is returned with a document title, such as search result title 146. Other embodiments are possible and known to the worker skilled in the art. For example, search results 144A, 144B, 144C and 144D could also include a document abstract as well as the URL of the document. Each of search results 144A, 144B, 144C and 144D is also returned with a respective one of user feedback mechanisms 148A, 148B, 148C and 148D. The user feedback mechanisms are in the form of a dichotomous question, such as “Was this helpful?” Each user feedback mechanism gives the user two possible answers, represented as hyperlinks labeled as “Yes” or “No.” For each possible answer, the number of users who have provided that user feedback response to the search result document is also provided in brackets. For example, in search result 144A, 23 users provided a “Yes” user feedback response, whereas 2 users provided a “No” user feedback response. In search result 144B, 13 users provided a “Yes” user feedback response, whereas 3 users provided a “No” user feedback response. Each time a user feedback response is provided for a document, the medical search engine stores the response along with the evaluated features of that document. This stored information is then used by the learning machine algorithms of the disclosed technique to increase the performance of the medical search engine, as described above in FIG. 1. As mentioned above in FIG. 1, a user can provide a user feedback response to a document before viewing the document by selecting either the “Yes” hyperlink or the “No” hyperlink. Users can also view a document and then return to the search results listed and then provide a user feedback response.

Interface 130 also includes page list selector 150 which enables a user to scroll through the various pages of search results returned. Interface 130 also includes online community interface 152, wherein a user can ask a medically related question to the online community of the medical search engine and receive an answer. The user may require a user profile to be able to submit a question to the online community. Interface 130 also includes chat interface 154, wherein a user can begin an online chat with another user whose profile is related to the medical search query of the user. For example, online user link 155 represents another online user who has a profile in which the term lactose intolerance, or a term related to lactose intolerance, based on a medical dictionary or a medical ontology, is mentioned. When the user entered their medical search query, besides searching for web pages, the medical search engine also searched for online users of the medical search engine community whose profiles mentioned the terms of the medical search query. In addition, interface 130 also includes questions interface 156, wherein previous questions asked to the online community of the medical search engine and previous answers provided by that community are shown as search results to the user. When the user entered their medical search query, besides searching for web pages, the medical search engine also searched for questions asked to the medical search engine online community which mentioned the terms, or related terms of the medical search query. Furthermore, a videos interface (not shown) can be included in interface 130, wherein videos related to the medical search query are shown as search results to the user. When the user entered their medical search query, besides searching for web pages, the medical search engine also searched for videos, such as those available on video sharing websites like YouTube, which mentioned in their description the terms, or related terms of the medical search query.

Reference is now made to FIG. 3, which is a schematic illustration showing a method for enhancing a user's medical search query, operative in accordance with a further embodiment of the disclosed technique. FIG. 3 show the sub-procedures involved in procedure 104 (FIG. 1). In procedure 170, terms from the user's medical search query are extracted and classified based on a medical ontology according to predefined semantic types. It is noted that terms can refer to words, such as “asthma,” “diabetes” or “ibuprofen,” or phrases such as “high blood pressure,” “prostate gland” or “chronic gallbladder disease.” In general, in the fields of computer science and information science, an ontology refers to a set of concepts in a domain and the relation of those concepts in that domain. In particular, a medical ontology is a set of concepts in the medical domain which can include diseases, body parts, organ, tissues, vitamins, treatments, medications, symptoms, alternative treatments and the like. In the ontology, each concept can be defined according to a list of attributes which are unique to that concept. In addition, concepts can be coupled together into different types of relations. For example, the concept ‘disease’ may be defined as including the attributes of ‘impairment of normal bodily function’ and ‘pain.’ Concepts such as ‘heart disease’ or ‘lung disease’ could be defined as including specific signs and symptoms related to heart disease or lung disease. As mentioned above, concepts can be coupled together into different types of relations. For example, the concept ‘heart disease’ may be coupled with the concept ‘disease’ as an is-a-type-of relation, meaning the concept ‘heart disease’ is-a-type-of the concept ‘disease.’ In this example, since the concept ‘heart disease’ is-a-type-of the concept ‘disease’ then the concept ‘heart disease’ includes all of its attributes in addition to the attributes of the concept ‘disease,’ namely ‘impairment of normal bodily function’ and ‘pain.’ Other relations are possible such as is-an-abbreviation-for, is-a-synonym-of, is-a-treatment-for and the like. Such relations and attributes are defined by skilled workers in the art who design and construct ontologies.

The medical field in particular is different than other fields of human endeavor in that significant amounts of financial as well as human resources have been spent in developing extensive medical ontologies. Such ontologies, like the UMLS, include the entire contents of numerous medical dictionaries and medical knowledge bases and may include over a million concepts. These ontologies are constantly updated and include entries for substantially all medical concepts known in the art. Each concept is grouped according to its attribute or attributes, and concepts are grouped together into relations. For example, diseases may be grouped into relations that couple them with their respective signs and symptoms. Synonyms and abbreviations for diseases, such as GBS, Guillain-Barré syndrome, French Polio, Landry's ascending paralysis and acute inflammatory demyelinating polyneuropathy may be grouped into a relation that couples each concept as a synonym or abbreviation of the other.

In procedure 170, the user's medical search query, which was received in procedure 102 (FIG. 1) is parsed according to a medical ontology. Terms from the medical search query are extracted and classified based on a medical ontology according to predefined semantic types, as described below. As an example, throughout the specification the UMLS will be used in examples to describe the disclosed technique, although it is noted that other medical ontologies may be used with the disclosed technique. According to the disclosed technique, terms in a user's medical search query can be classified as one of four predefined semantic types:
1. Medical term
2. Relevant non-medical term
3. Non-medical term
4. Stop word

Medical terms relate to words and phrases which are found in medical ontologies and medical dictionaries and which relate directly to medical concepts. For example, “ascorbic acid,” “pancreas,” “Adjuvant chemotherapy” and “malnutrition” are all examples of medical terms which are found in medical ontologies and medical dictionaries. Relevant non-medical terms relate to words and phrases which can modify the meaning of a medical term, and are usually qualitative and quantitative concepts. For example, “child,” “milligrams,” “before” and “after” are all examples of relevant non-medical terms, as they relate to words or phrases which can modify the meaning of a medical term. The term “child cancer” is different than the term “cancer,” and the term “100 micrograms vitamin D” is different than the term “vitamin D.” Relevant non-medical terms are included in medical ontologies and may be included in medical dictionaries. Stop words relate to a list of words which state of the art search engine filter out from search queries and includes words such as “I,” “you,” “what” and “the.” Stop word lists are known in the art and usually include about 100 to 150 words. Non-medical terms relate to words and phrases in a user's medical search query which cannot be classified as one of the previous types, and can be referred to as unknown terms. In addition, according to the disclosed technique, the various concepts in the UMLS can be divided into groups, also known as semantic types, which broadly describe the different types of medical concepts a user may be searching information about via their medical search query. For example, the semantic types may include drugs, symptoms, treatments, disease and substances. Other semantic types are possible and are a matter of design choice. It is noted that the predefined semantic types of the disclosed technique can be updated and modified over time. The predefined semantic types of the UMLS further classify the semantic types medical term and relevant non-medical term. It is noted that in the UMLS, individual terms may be classified according to a particular semantic type, but a modifier term, which may be a non-medical term, coupled with the term may change the classification of the term. For example, the term “heart” may be classified as an organ, but with the modifier term “enlarged,” the term “enlarged heart” may be classified as a diagnosis.

In this procedure, terms in the medical search query of the user are extracted and classified according to the predefined semantic types mentioned above. First the medical search query is analyzed for medical terms, with phrases taking precedence over single word terms. In general, the longer the phrase, the higher precedence the phrase has. Precedence in this respect relates to the order in which terms are searched, and as described below in procedure 174, the assigned weight to the terms found. For example, in a medical search query such as “I am taking lipitor and have high blood pressure problems looking for alternative treatments in Japan,” the medical phrase “high blood pressure” will take precedence over the medical phrase “blood pressure” which will in turn take precedence over the medical phrases “blood” and “pressure.” Terms in the user's medical search query are extracted and classified as medical terms if they are found in the UMLS. In the above example, besides the term “high blood pressure,” the terms “lipitor” and “alternative treatments” will also be classified as medical terms. After medical terms are searched for in the user's medical search query, relevant non-medical terms are searched for. Using the example above, the terms “taking” and “problems” are extracted and classified as relevant non-medical terms. It is noted that since medical terms and relevant non-medical terms are both found in the UMLS, both semantic types can be searched for simultaneously in the user's medical search query.

Once medical terms and relevant non-medical terms have been extracted and classified, stop words are located in the user's medical search query and filtered out of the medical search query. Using the above example, the terms “I,” “am,” “and,” “for” and “in” are extracted and classified as stop words, based on a predefined list of stop words. The words in the user's medical search query which have not been extracted and classified as one of the three aforementioned semantic types are classified as non-medical, or unknown terms. Using the above example, the terms “have,” “looking” and “Japan” are each extracted and classified as non-medical terms. It is noted that the order in which semantic types are extracted and classified in the user's medical search query is significant. By first searching for terms which appear in the UMLS and only then searching for stop words and non-medical terms, the probability is increased that all medical and relevant non-medical terms in the user's medical search query are extracted and classified. In other words, the “understanding” of the user's medical search query is increased. For example, if a user's medical search query includes the terms “hepatitis A” or “vitamin A,” by extracting and classifying stop words and non-medical terms first, the term “A” would be filtered out and the medical terms “hepatitis” and “vitamin” would be extracted and classified. By first extracting and classifying medical and relevant non-medical terms first, this issue is avoided.

As part of procedure 170, terms in the user's medical search query which are classified as medical terms and relevant non-medical terms are also classified according to the predefined semantic types of the UMLS. Using the above example, the term “lipitor” may be further classified as a drug, the term “high blood pressure” as a disease, the term “blood pressure” as an organism function, the term “blood” as a substance, the term “pressure” as a finding, the term “high” as a qualitative modifier, the term “alternative treatments” as a biomedical occupation or discipline, the term “alternative” as a qualitative modifier and the term “treatments” as a therapeutic or preventive procedure. The extraction of terms from the user's medical query according to the UMLS can be executed in real time using an information retrieval library system such as Lucene.

In procedure 172, once all the terms of the user's medical search query have been extracted and classified according to various predefined semantic types, each term which was classified as either a medical term or a relevant non-medical term, i.e. a term which is included in the UMLS, is expanded. As the UMLS is an ontology, terms which are included in the UMLS are classified according to their attributes as well as their relation to other terms and concepts. In procedure 172, all the extracted terms which are included in the UMLS are expanded by using the UMLS, thereby generating an expanded set of terms. Term expansion involves using the UMLS to locate terms which are abbreviations, synonymous with or related to the extracted terms. The procedure of expanding is used to increase recall, to increase the number of documents retrieved for the user's medical search query which otherwise would not have been retrieved due to how the user's medical search query was phrased. As the UMLS is an ontology, this procedure is feasible in real time since the UMLS groups terms according to concept identifiers which interlink the terms in the ontology. For example, for the term “high blood pressure,” an expanded set of terms may include “HBP,” “hypertension,” “HTN” and “arterial hypertension,” whereas for the term “lipitor,” an expanded set of terms may include “atorvastatin” and “cholesterol reducer.” Certain terms may be unique enough in the UMLS that the expanded set of terms is null. At the end of procedure 172, each term in the user's medical search query has been extracted, classified according to a predefined semantic type, and depending on its semantic type, expanded using the UMLS. It is noted that expanding the terms of the user's search query may increase the recall of documents returned as relevant documents, but such an increase in recall may also increase the precision of the documents returned as search results.

In procedure 174, each expanded set of terms is augmented according to a rule based system which uses a set of weighted semantic features. The expanded set of terms also includes non-medical terms which are not expanded in procedure 172. According to the rule based system various attributes and weights are assigned to each term in the expanded set of terms as well as to combinations of terms in the expanded set of terms. Non-medical terms can also be assigned attributes and weights. The attributes and weights are a function of the significance of a particular term to the user's medical search query, which determines the relevance score for a particular document given a user's enhanced medical search query. The procedure of augmentation is used to increase precision, as the attributes and weights assigned to the various terms in the user's augmented medical search query assign higher relevance scores to documents which are substantially similar to the user's medical search query. For example, according to the rule based system an attribute may be assigned to a particular term designating whether the term is mandatory (i.e. must appear), should not appear or should appear in a document returned in a search result based on the user's medical search query. Using the example above, in the expanded set of the term “high blood pressure,” the terms “high blood pressure,” “hypertension,” “HTN” and “HBP” may be designated as mandatory terms, whereas the expanded set of terms for the terms “blood” and “pressure” may be designated as should not appear. According to the rule based system, terms which are phrases may be assigned as mandatory in the search results whereas the words which make up the phrase may be assigned as should either appear or should not appear. For example, documents in which the term “high” appears but the terms “blood” and “pressure” do not appear may not be considered relevant at all and given a relevance score of zero since mandatory terms like “blood pressure” do not appear in the documents. In addition, non-medical terms may be classified as should appear, should not appear or mandatory. For example, the non-medical term “Japan” may be classified as mandatory, whereas the terms “having” and “looking” may be classified as should appear.

According to the rule based system, a weight may be assigned to each term in the expanded set of terms depending on the semantic type of the term. For example, predefined semantic types such as drug and disease may be given a weight of 0.9, whereas predefined semantic types such as body part and tissue may be given a weight of 0.6. In one embodiment of the disclosed technique, the weights assigned to predefined semantic types are determined manually. In another embodiment of the disclosed technique, as described below in procedure 178, at least one machine learning algorithm can be used to determine appropriate weights for each predefined semantic type. In this embodiment, the user feedback responses from procedure 112 (FIG. 1) are used as input to the at least one machine learning algorithm. In this respect, the rule based system can be considered a learning based system, as the rules used to augment the set of expanded terms are constantly updated as the at least one machine learning algorithm “learns” what assignment of weights increases the relevance of the search results returned to the user. In addition, terms in the set of expanded terms may be grouped together and given a particular weight to increase the importance of a subset of the terms in the user's search query. Using the example stated above, the term “high blood pressure” may be given a weight of 0.9, whereas the terms “lipitor high blood pressure” may be given a weight of 0.95, indicating that a document which is searched which has the terms high blood pressure and lipitor next to one another is to be given a higher relevance score. Furthermore, depending on the user's medical search query, certain semantic types may be given low weights to reduce the relevance of documents which may include the terms of the user's medical search query as well as additional terms. For example, if the user's medical search query was “asthma and children,” then according to the rule based system, predefined semantic types such as symptoms and treatments may be assigned a low weight to reduce the relevance score of documents which include the terms asthma and children but also terms relating to symptoms and treatments for asthma. The rule based system may indicate that medical search queries which do not include the terms “symptoms” or “treatments” should be treated as a general information inquiry, and therefore documents which do include specific information regarding the medical search query, such as symptoms or treatments, are to be assigned a lower relevance score. In addition, the rule based system may determine the minimal number of times a particular term must appear in a document and may assign a low relevance score to documents which include more than one type of specified semantic type. For example, if the user's medical search query was “enlarged heart” then documents which include the term “heart” as well as other terms which are classified as organs may be assigned a low relevance score since these documents are not specific enough to the user's medical search query.

After procedure 174, each term in the set of expanded terms has been augmented according to a rule based system, in particular using weights to indicate how relevant the term is to the user's medical search query. In procedure 176, all the terms in the augmented set of expanded terms are concatenated together form an enhanced medical search query. Referring back to FIG. 1, the enhanced medical search query generated in procedure 176 (FIG. 3) is used in procedure 106 (FIG. 1) to retrieve all the documents in the inverted index which are relevant to the enhanced search query. As mentioned above, relevant is defined as a document which has a minimal relevance score based on the user's enhanced medical search query. Using the enhanced medical search query, in which the various terms of the search query are weighted, a TF-IDF searching technique can be used in procedure 106 to find documents in the inverted index which have the highest relevance score. Unlike prior art systems, the relevance score according to the disclosed technique is not based on the term frequency (i.e., the more frequent the search query terms appear in the document, the more relevant the document is to the search query) but rather on the weights of the terms in the enhanced medical search query (i.e., the higher the relevance score of the document based on the weights of the terms, the more relevant the document is to the user's medical search query).

Referring back to FIG. 3, in procedure 176, all the augmented terms of the expanded set of terms are concatenated based on a rule based system which determines how the various terms are concatenated into a single medical search query. The rule based system may define the various operators used to concatenate the terms as well as additional weights, for example in the form of multiples or exponents, for increasing the relevance, i.e. boosting the relevance, of certain terms and combinations of terms in the enhanced medical search query. For example, synonymous terms, such as “high blood pressure,” “hypertension,” “HTN” and “HBP” may be concatenated with an ‘OR’ operator. When a plurality of higher weighted predefined semantic types are assigned to terms included in the user's medical search query (such as an organ and a disease, as mentioned above), the rule based system may define that such terms together be given an additional weight. Operators may be defined that specify the maximal allowed proximity (i.e., the distance) between groups of terms. As can be seen, the enhanced medical search query substantially defines a search query where the various terms of the search query are weighted in various ways to better represent what the user is looking for. Based on the enhanced medical search query, relevant documents are retrieved as search results based on how similar they are to the enhanced medical search query. It is noted that the particular rules of the rule based system, as mentioned above in procedures 174 and 176, are examples of what the rule based system may define and are a matter of design choice. Many such rule based systems are known to workers skilled in the art.

In procedure 178, the rule based system is optimized using at least one machine learning algorithm. It is noted that procedure 178 is an optional procedure. As mentioned above, the feedback responses from users in procedure 112 (FIG. 1) can be used as input to a machine learning algorithm along with the rules and weights defined by the rule based system. As feedback responses are received from users, the at least one machine learning algorithm can optimize the rules and weights defined by the rule based system to increase the relevance score retrieved documents receive based on the user's enhanced medical search query. The enhanced user's medical search query can be modeled as a polynomial with the assigned weights and attributes for each term in the search query representing coefficients in the polynomial. Given a plurality of enhanced medical search queries, the at least one machine learning algorithm can optimize the coefficients in the polynomial, thereby determining the optimal values for the weights and attributes assigned to the terms in the enhanced medical search query. If procedure 178 is executed, it is usually done offline and not while user medical search queries are being analyzed according to procedures 170 to 176.

Two examples are now offered to demonstrate procedures 170 to 176. In a first example, a user's medical search query may be “Is it dangerous to mix alcohol and antibiotics?” In procedure 170, each term in the medical search query is extracted and classified according to predefined semantic types. The terms “alcohol” and “antibiotics” are classified as medical terms, which are further classified according to the UMLS. Both “alcohol” and “antibiotics” are classified as drugs. The terms “dangerous” and “mix” are the classified as non-medical terms. It is noted that in this example, there are no relevant non-medical terms. Finally, the terms “Is,” “it,” “to” and “and” are classified as stop words. In procedure 172, terms which are included in the UMLS (i.e., those classified as medical terms or relevant non-medical terms) are expanded. The term “alcohol” may be expanded to “alcoholic beverages” and “drinkable liquids ethanol,” whereas the term “antibiotics” may be expanded to “antibacterial agents” and “antimycobacterial agents.” In procedure 174, the set of expanded terms are augmented using a set of weighted semantic features according to a rule based system. For example, the terms “alcohol” and “alcoholic beverages” may be assigned as mandatory terms whereas the term “drinkable liquids ethanol” may be assigned as a term that should appear. In addition, the terms “alcohol” and “alcoholic beverages” may be assigned a weight of 0.8 whereas the term “drinkable liquids ethanol” may be assigned a weight of 0.7. The terms “antibiotics,” “antibacterial agents” and “antimycobacterial agents” may be assigned as mandatory terms. In procedure 176, the augmented set of expanded terms is concatenated together according to a rule based system. As a search query, the enhanced medical search query may be written as:
+((+alcohol OR +“alcoholic beverages”)̂0.8 (+antibiotics OR +“antibacterial agents” OR +“antimycobacterial agents))̂4 “drinkable liquids ethanol”̂0.7 danger mix
   where a ‘+’ sign indicates that a term is mandatory and a ‘̂’ sign indicates that a score assigned for a particular term, such as the term frequency of the term in the document, is multiplied by the number immediately following the ‘̂’ sign. The enhanced medical search query is now used in procedure 106 (FIG. 1) to retrieve documents from the inverted index, with each document receiving a relevance score.

In a second example, a user's medical search query may be “plaque psoriasis phototherapy treatment.” In procedure 170, each term in the medical search query is extracted and classified according to predefined semantic types. The terms “plaque psoriasis,” “psoriasis” and “phototherapy” are classified as medical terms, which are further classified according to the UMLS. “plaque psoriasis” and “psoriasis” are classified as diseases and “phototherapy” is classified as a medical device. It is noted that the term “plaque” is not classified as a term since it is a modifier to the term “psoriasis” according to the UMLS, and has no medical significance as a single term. The term “treatment” is classified under a predefined semantic type such as informational need and includes semantic types such as treatments, causes and symptoms. In this example, there are no relevant non-medical terms, non-medical terms or stop words. In procedure 172, terms which are included in the UMLS are expanded. The term “plaque psoriasis” may be expanded to “parapsoriasis” and “parapsoriasis en plaques,” the term “psoriasis” may be expanded to “palmoplantaris pustulosis” and “pustulosis of palms and soles” and the term “phototherapy” may be expanded to “light therapy” and “photoradiation therapy.” In procedure 174, the set of expanded terms are augmented using a set of weighted semantic features according to a rule based system. For example, the terms “plaque psoriasis,” “psoriasis” and “phototherapy” may be assigned as mandatory terms whereas the term “treatment” may be assigned as a term that should appear. In addition, the term “psoriasis” by itself may be assigned a weight of 0.5. In procedure 176, the augmented set of expanded terms is concatenated together according to a rule based system. As a search query, the enhanced medical search query may be written as:

+(+((“plaque psoriasis” OR parapsoriasis OR “parapsoriasis en plaques”) XOR (psoriasis OR “palmoplantaris pustulosis” OR “pustulosis of palms and soles”)̂0.5)+(phototherapy OR “light therapy” OR “photoradiation therapy”))̂4 treatment

where XOR represents a logical operator that prevents an increase in the relevance score when terms on both sides of the operator exist in a document. The enhanced medical search query is now used in procedure 106 (FIG. 1) to retrieve documents from the inverted index, with each document receiving a relevance score.

As mentioned above, the disclosed technique for implementing a medical search engine using user feedback to returned search results to enhance the quality of the returned search results is applicable not only to websites but to all types of documents. For example, the procedures described in FIGS. 1 and 3 can be modified to relate to online communities forums and videos, as shown in FIG. 2, for example online community interface 152 (FIG. 2), questions interface 156 (FIG. 2) and videos interface (referenced but not shown in FIG. 2). In procedure 100, the inverted index generated would be specifically for user posts on medical forums and online communities that relate to the medical field. Posts on forums could be general posts as well as answers to questions posted on the forums. In addition, the inverted index would include questions submitted to online medical communities and the answers to those questions received from those communities. As mentioned above, the actual user posts and answers may be stored in a database which is accessible to the inverted index. In procedure 102, a user would submit a medical search query to an online forum or community, but which would also be received by a medical search engine using the disclosed technique. When a user submits a medical search query which is received by the medical search engine, the user's medical search query is enhanced in procedure 104 using weighted semantic features and a medical ontology, as described above in FIG. 3. In procedure 106, all the documents in the inverted index which are relevant to the user's enhanced medical search query are retrieved. In procedure 108, the retrieved documents, which in this case would be posts, are ranked based on a master expression. The master expression would define features of forums, online communities and the description of online videos as well as features of the questions and answers posted and provided on those forums and communities. Features of useful posts and questions might include the number of replies to the post (or answers to the question), indicating a popular or interesting question, the number of people that have opened the full post page (i.e., versus the preview that is displayed in the search results or forum), whether the author of the post or question filled the body field of the question or just filled the title field, indicating that the question is short and therefore missing background details, and the profile of the questioner or answerers to estimate if health experts participated in the thread.

As mentioned above, the master expression can be a general master expression for medical search queries. In addition, various master expressions can be defined for different medical subjects and master expressions can also be personalized. The ranked posts, questions and answers would be returned to the user in procedure 110, besides any answers users from the online community may have provided to the medical search query of the user, who could then provide user feedback responses regarding the returned search results. In procedures 112 and 114, the features of documents to which user feedback responses were provided for would be evaluated, at least those which were not initially stored in the inverted index, and the master expression would be modified using at least one machine learning algorithm. As more users provide feedback, the features, and the weights of those features, which increase the probability that a user will give positive user feedback responses to posts, questions and answers on forums and online communities can be determined, thereby increasing the performance of the medical search engine of the disclosed technique.

As described above in FIG. 2, if a user submits a medical search query to an online community, via online community interface 152, according to the disclosed technique, the user can be presented with search results, or answers, from three different sources. First, the user can be presented with answers submitted by other users of the online community. Second, using the disclosed technique described in FIGS. 1 and 3, the medical search query of the user can be analyzed and enhanced, and documents, such as websites, including video sharing websites, can be returned as search results to the user. According to the disclosed technique, the documents returned are of high precision vis-à-vis the user's medical search query. Third, if the inverted index also includes questions and answers from user posts on the online community and on forums, then based on the analysis and enhancement of the user's medical search query, answers to questions similar to the user's medical search query can be presented to the user. Regarding the third source of search results presented to the user, the disclosed technique can be used as an automatic forum or online community moderator. Based on the enhanced medical search query of the user, the medical search engine of the disclosed technique can semantically classify the medical search query of the user and automatically find answers to the user's medical search query from a database of answers to medical search queries.

It will be appreciated by persons skilled in the art that the disclosed technique is not limited to what has been particularly shown and described hereinabove. Rather the scope of the disclosed technique is defined only by the claims, which follow.

1. A method for enhancing the performance of a medical search engine, comprising the procedures of:
generating an inverted index of medical related documents;
receiving a medical search query from a user;
expanding and augmenting said received medical search query, thereby generating an enhanced medical search query;
retrieving all said medical related documents in said inverted index which are relevant to said enhanced medical search query;
ranking said retrieved medical related documents according to a master expression;
presenting said ranked retrieved medical related documents to said user;
receiving at least one user feedback response from said user to a respective at least one of said ranked retrieved medical related documents;
for each said received user feedback response, evaluating and storing at least one feature of said respective at least one of said ranked retrieved medical related documents; and
modifying said master expression based on said received user feedback response using at least one machine learning algorithm.

2. The method according to claim 1, wherein said procedure of generating said inverted index comprises the sub-procedure of updating said inverted index at regular intervals.

3. The method according to claim 1, wherein said procedure of generating said inverted index comprises the sub-procedure of deriving said inverted index from a directory of medical related documents accessible on the World Wide Web.

4. The method according to claim 1, wherein said procedure of generating said inverted index comprises the sub-procedures of:
deriving said inverted index from a plurality of documents accessible on the World Wide Web; and
filtering out at least one document from said plurality of documents which do not include at least one medical word specified in a list of medical words.

5. The method according to claim 1, wherein said procedure of generating said inverted index comprises the sub-procedure of generating an N-dimensional matrix including a plurality of vectors, each one of said plurality of vectors representing a respective one of said medical related documents, each one of said plurality of vectors storing at least one term of medical significance which relates to at least one term occurring in said medical related documents.

6. The method according to claim 5, wherein said at least one term of medical significance is selected from the list consisting of:
a synonym;
an abbreviation;
a related term; and
a related phrase.

7. The method according to claim 1, wherein said master expression is embodied as a decision tree.

8. The method according to claim 1, wherein said at least one feature is related to said medical search query.

9. The method according to claim 1, wherein said at least one feature is unrelated to said medical search query.

10. The method according to claim 1, wherein said at least one user feedback response comprises a response selected from the list consisting of:
a response to a dichotomous question;
a response to a question based on a given scale; and
indirectly tracking the behavior of said user vis-à-vis said presented ranked retrieved medical related documents.

11. The method according to claim 1, further comprising a preprocessing procedure of selecting features from a training set of documents from said inverted index of medical related documents using a feature selection algorithm.

12. The method according to claim 1, wherein said procedure of receiving at least one user feedback response comprises the sub-procedure of determining if said user feedback response is fraudulent using at least one fraud detection technique.

13. The method according to claim 1, wherein said enhanced medical search query comprises a set of weighted semantic features, wherein said medical related documents are considered relevant according to said set of weighted semantic features.

14. A method for enhancing the performance of a medical search engine, comprising the procedures of:
generating an inverted index of medical related documents;
receiving a medical search query from a user;
classifying said medical search query according to at least one subject;
expanding and augmenting said received medical search query according to said at least one subject, thereby generating a subject classified enhanced medical search query;
retrieving all said medical related documents in said inverted index which are relevant to said subject classified enhanced medical search query;
ranking said retrieved medical related documents according to a master expression, said master expression being specific to said at least one subject;
presenting said ranked retrieved medical related documents to said user;
receiving at least one user feedback response from said user to a respective at least one of said ranked retrieved medical related documents;
for each said received user feedback response, evaluating and storing at least one feature of said respective at least one of said ranked retrieved medical related documents; and
modifying said master expression based on said received user feedback response using at least one machine learning algorithm.

15. A method for enhancing the performance of a medical search engine, comprising the procedures of:
generating an inverted index of medical related documents;
receiving a login from a user, said login generating a user profile;
receiving a medical search query from said user;
expanding and augmenting said received medical search query, thereby generating an enhanced medical search query;
retrieving all said medical related documents in said inverted index which are relevant to said enhanced medical search query;
ranking said retrieved medical related documents according to a master expression, said master expression being specific to said user profile;
presenting said ranked retrieved medical related documents to said user;
receiving at least one user feedback response from said user to a respective at least one of said ranked retrieved medical related documents;
storing said received at least one user feedback response from said user in said user profile;
for each said stored received user feedback response, evaluating and storing at least one feature of said respective at least one of said ranked retrieved medical related documents; and
modifying said master expression based on said stored received user feedback response using at least one machine learning algorithm.

16. A method for enhancing a user's medical search query based on semantic analysis, comprising the procedures of:
receiving a medical search query from a user;
parsing all terms in said medical search query based on a medical ontology according to predefined semantic types;
expanding each parsed term in said medical search query based on said medical ontology, thereby generating a set of expanded terms;
augmenting said set of expanded terms according to a rule based system using a set of weighted semantic features thereby generating an augmented set of expanded terms; and
concatenating said augmented set of expanded terms into an enhanced medical search query according to said rule based system.

17. The method according to claim 16, further comprising the procedure of optimizing said rule based system using at least one machine learning algorithm.

18. The method according to claim 16, further comprising the procedure of classifying each parsed term based on said medical ontology according to predefined semantic types, wherein longer parsed terms are classified before shorter parsed terms.

19. The method according to claim 16, wherein said predefined semantic types are selected form the list consisting of:
a medical term;
a relevant non-medical term;
a non-medical term; and
a stop word.

20. The method according to claim 16, further comprising the procedure of augmenting said set of expanded terms according to said rule based system using a set of attributes.
